(19) United States
(12) Patent Application Publication
(10) Pub. No.: US 2021/0190319 A1
(43) Pub. Date: Jun. 24, 2021

(54) TUBULAR COMBUSTION CHAMBER WITH CERAMIC CLADDING

(71) Applicant: Siemens Aktiengesellschaft, Munich (DE)

(72) Inventors: Matthias Gralki, Mulheim an der Ruhr (DE); Marvin Hümbs, Duisburg (DE); Claus Krusch, Essen (DE); Daniel Schmidt, Mülheim an der Ruhr (DE); Holger Grote, Mülheim (DE); Marc Tertilt, Hattingen (DE)

(73) Assignee: Siemens Aktiengesellschaft, Munich (DE)

(21) Appl. No.: 16/771,060

(22) PCT Filed: Nov. 15, 2018
(86) PCT No.: PCT/EP2018/081305

§ 371 Date: Jun. 9, 2020

(30) Foreign Application Priority Data
Dec. 12, 2017 (EP) 17206622.7

(51) Int. Cl. F23R 3/00; F23C 3/00; F23R 3/46; F23R 3/50

(52) U.S. Cl. CPC F23R 3/007; F23C 3/002; F23R 3/46; F23D 2900/00018; F23R 2900/00017; F23D 2212/10; F23R 3/50

(57) ABSTRACT

A combustion chamber with a jacket arranged around a principal axis of the combustion chamber, a ceramic tube that is arranged inside the jacket, wherein an intermediate layer is arranged between the jacket and the ceramic tube. The jacket is at least partially conical. The ceramic tube is under axial stress in the jacket along the principal axis. The ceramic tube is an assembly of multiple heat shield segments. The heat shield segments each have a hot side that is designed to come into contact with a hot medium, a cold side that is opposite the hot side and is oriented toward the jacket, and a circumferential rim between the hot side and the cold side. In the cold state, individual heat shield segments of a segment row have, on the rim, bearing surfaces that the adjoin the cold side and gaps that open toward the hot gas side.

### CROSS REFERENCE TO RELATED APPLICATIONS

This application is the US National Stage of International Application No. PCT/EP2018/081305 filed 15 Nov. 2018, and claims the benefit thereof. The International Application claims the benefit of European Application No. EP17206622 filed 12 Dec. 2017. All of the applications are incorporated by reference herein in their entirety.

### FIELD OF INVENTION

The invention relates to a tubular combustion chamber with ceramic cladding.

### BACKGROUND OF INVENTION

In order to produce a ceramically clad tubular combustion chamber, a design appropriate to material and installation is necessary.

The careful integration of the brittle ceramic monoliths into the metal environment is particularly important since the tubular combustion chamber is exposed to severe combustion oscillations or vibrations. The vibration-damping, permanent mounting of the ceramic is therefore a main design object. During the mounting, care should be taken in particular to ensure that fitting of the ceramic into the housing does not cause the ceramic to be exposed to any critical tensile or shearing load. During operation, in addition to the assembly stresses caused by the mounting, the ceramic insert experiences the load stresses arising due to the combustion. Said loads together with the production-induced inherent stresses result in the overall distribution of stresses, in which tensile stresses critical for the component can be combined with compressive stresses without causing damage. A combustion chamber with a cladding is disclosed, for example, in WO 2015/038293.

### SUMMARY OF INVENTION

It is the object of the invention to fit such a ceramic insert carefully into the metallic jacket of a combustion chamber and optionally to configure an interface geometry of ceramic segments of such a combustion chamber with one another in such a manner that thermal expansions are not obstructed. Furthermore, the interface geometry has to meet various additional functions, such as the transmission of axial and radial assembly loads, the unambiguous definition of the position and anti-twist protection of the individual elements, the sealing between the hot and the cold gas side, and the avoidance of tensile stresses in the interface region.

The invention achieves the object, which is directed toward a combustion chamber, by making provision that, in such a combustion chamber, comprising a jacket which is arranged around a principal axis of the combustion chamber, and a ceramic tube which is arranged inside the jacket, an intermediate layer is arranged between the jacket and the ceramic tube, the jacket is at least partially conical, and the ceramic tube is axially tensioned into the jacket along the principal axis, wherein the ceramic tube is an assembly of a plurality of heat shield segments, and wherein individual heat shield segments of a segment row, which heat shield segments each have a hot side to which a hot medium can be applied, a cold side which is opposite the hot side and faces the jacket, and a circumferential rim between the hot side and the cold side, on the rim, in the cold state, have bearing surfaces adjoining the cold side and gaps opening toward the hot gas side.

In the design with individual segments, the latter are held in position in a form-fitting and force-fitting manner (archway principle) and thus form a precompressed ceramic ring. Precompression is realized by axial tensioning of the heat shield segments in a conical counter surface.

Differences in thermal expansion occur in particular between the hot side and the cold side of the ceramic segments. It is particularly advantageous here if the gaps are sickle-shaped. The cold-side bearing surfaces of the individual segments serve for transmitting force in the tangential and axial direction. The sickle-shaped gaps opening toward the hot side, in a manner similar to a tongue and groove joint ensure firstly unobstructed thermal expansions and secondly a form fit and therefore a definition of the position in the radial direction. The side and end surface geometry should be designed in such a manner that the gap geometry thereof is adapted to the expansion and therefore the gaps are minimized during the operation in order very substantially to avoid the penetration of hot gas.

It is expedient if uneven end surfaces are provided between segment rows, and therefore, in the hot state, a form fit arises between individual heat shield segments in the circumferential direction. For the interface geometry, use should advantageously be made of obtuse angles and comparatively large radii in order to avoid zones loaded with tensile stress.

In an advantageous embodiment of the invention, the jacket is metallic.

In a further advantageous embodiment, the ceramic tube is composed of fireproof material.

It is advantageous if the intermediate layer is a ceramic swellable mat. Swellable mats are mineral fiber mats which contain expandable particles. Owing to their elastic restoring forces, they exert a holding force on the ceramic tube. The axial tensioning of the heat shield segments leads to the production of radial forces which are reliably transmitted via said resilient elements to the ceramic outer surface.

Alternatively, it is advantageous if the intermediate layer comprises spring and/or damping elements. These can be ceramic or metallic.

In an advantageous embodiment, the jacket has fastening means at the opening having the largest opening diameter, which fastening means can be used to draw a counterpart against the opening. For example, the axial tensioning can be brought about by a metal ring joined in a force-fitting and/or form-fitting manner. The force fit is undertaken by the metal ring via the ceramic column and spring mounting onto the metallic conical counter surface.

With the aim of limiting the joining forces and of cladding variable geometries, it may be advantageous if the jacket comprises two conical partial jackets, i.e. the jacket is then separated into two conical components (for example with a separating plane displaced into the center).

The ceramic tube itself may expediently be a full cylinder or a full cone.

In order to prevent rotation in the circumferential direction between the segment rows, the end surfaces are not even, but rather should be designed in such a manner that a form fit arises between the ceramic individual segments in the circumferential direction. For this purpose, the interface geometry should advantageously be realized in a wavy geometry or in any other geometry ensuring a form fit. Use should advantageously also be made here of obtuse angles and comparatively large radii.

For the cladding of a tubular combustion chamber, a ceramic assembly of a plurality of fireproof heat shield segments is therefore provided according to the invention. The resulting ring or cone made of fireproof ceramic is mounted in a metallic housing with the aid of a resilient intermediate layer. The ceramic segments are fastened via the external pressure, and therefore a design without gaps arises.

The invention makes it possible to realize fundamental design principles of a ceramic-metal assembly in combination with a component- and cost-reduced design. With the production of precompressions in the ceramic cladding, an increase in the loading capacity of the ceramic is made possible. The use of fireproof ceramic in a tubular combustion chamber leads to a reduction in new part and life cycle costs (by increasing the service life in comparison to the metallic solution). In addition, an increase in the temperature loading capacity and a reduction in the cooling air consumption are possible.

### BRIEF DESCRIPTION OF THE DRAWINGS

The invention will be explained in more detail by way of example with reference to the drawings, in which schematically and not to scale:

FIG. 1 shows a detail of an assembly solution for a combustion chamber consisting of the elements jacket, ceramic tube and intermediate layer,

FIG. 2 shows an illustration of the effective forces of the assembly solution from FIG. 1 in side view, and

FIG. 3 shows an illustration of the effective forces of the assembly solution from FIG. 1 in longitudinal view,

FIG. 4 shows the axial tensioning using the example of a metal ring in the open state and

FIG. 5 shows the axial tensioning using the example of a metal ring in the closed state,

FIG. 6 shows the principle of two conical components with a central separating plane,

FIG. 7 shows a cut-away tubular combustion chamber with a transition piece,

FIG. 8 shows a connection similar to a tongue and groove joint of heat shield segments with the bearing surface in the cold state,

FIG. 9 shows a connection similar to a tongue and groove joint of heat shield segments with the bearing surface and closed gap in the hot state, and

FIG. 10 shows a wavy geometry between various segment rows as anti-twist protection.

### DETAILED DESCRIPTION OF INVENTION

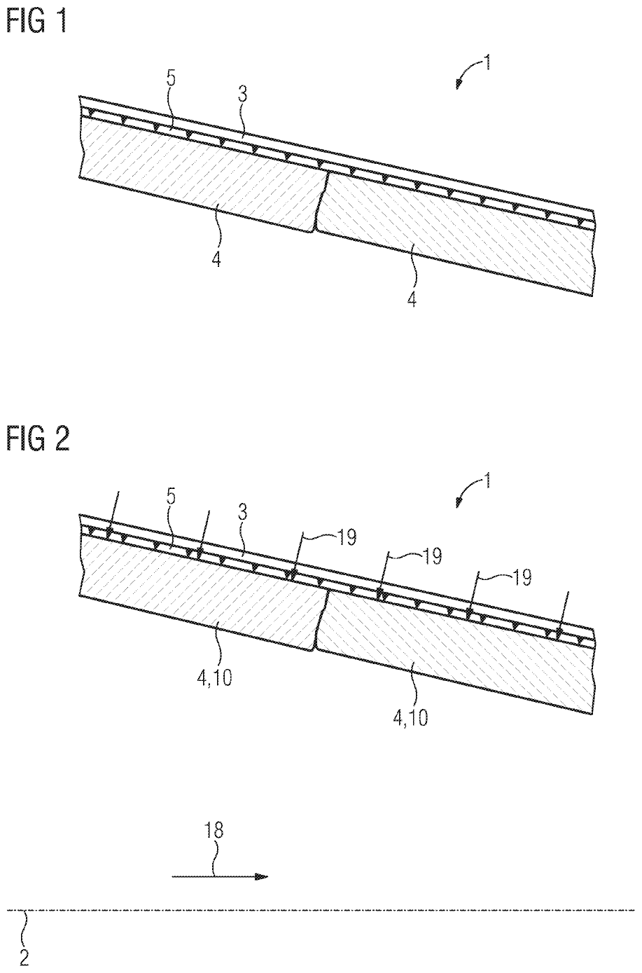

FIG. 1 shows schematically and by way of example an assembly solution consisting of three elements for a combustion chamber 1 with a jacket 3, a ceramic tube 4 made of fireproof material arranged in the jacket 3 and an intermediate layer 5 which is stable at high temperatures and is arranged between the jacket 3 and the ceramic tube 4.

The careful integration of the ceramic tube 4 into the metal environment is particularly important. FIG. 2 illustrates for this purpose the axial tensioning 18 according to the invention of the ceramic tube 4 in the jacket 3. The axial tensioning 18 of the ceramic tube in the direction of the principal axis 2 of a conical metallic counter surface, i.e. of the jacket, produces radial forces 19 which are transmitted to the ceramic outer surface via resilient elements, i.e. the intermediate layer 5. A ceramic assembly which is under external pressure is thereby produced.

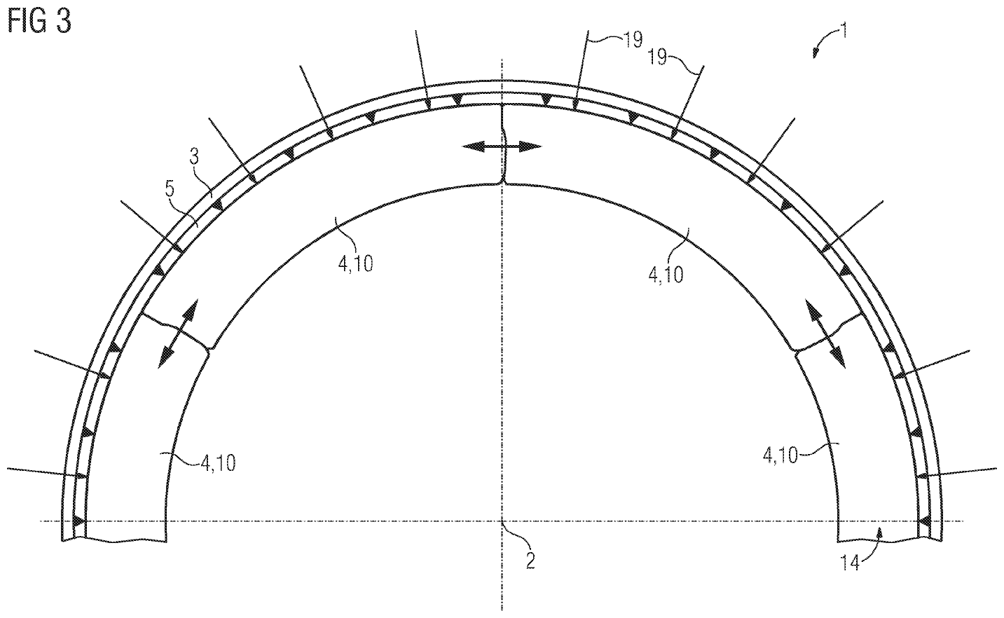

In the design according to the invention with individual heat shield segments 10, the latter are held in position in a form-fitting and force-fitting manner (archway principle) and thus form a precompressed ring of ceramic heat shield segments 10, as is shown as segment row 14 in FIG. 3.

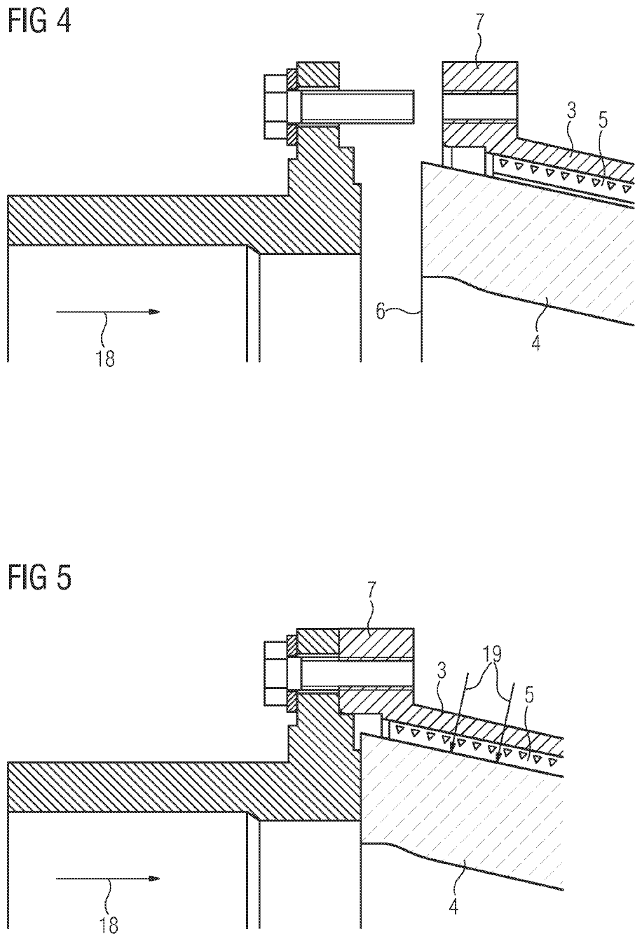

FIGS. 4 and 5 show by way of example how the axial tensioning 18 can be undertaken by a metal ring, which is joined in a force-fitting and/or form-fitting manner, as fastening means 7 in the region of the larger opening 6 of the cone. The force fit is undertaken by the metal ring via the ceramic column and spring mounting onto the metallic conical counter surface of the jacket 3.

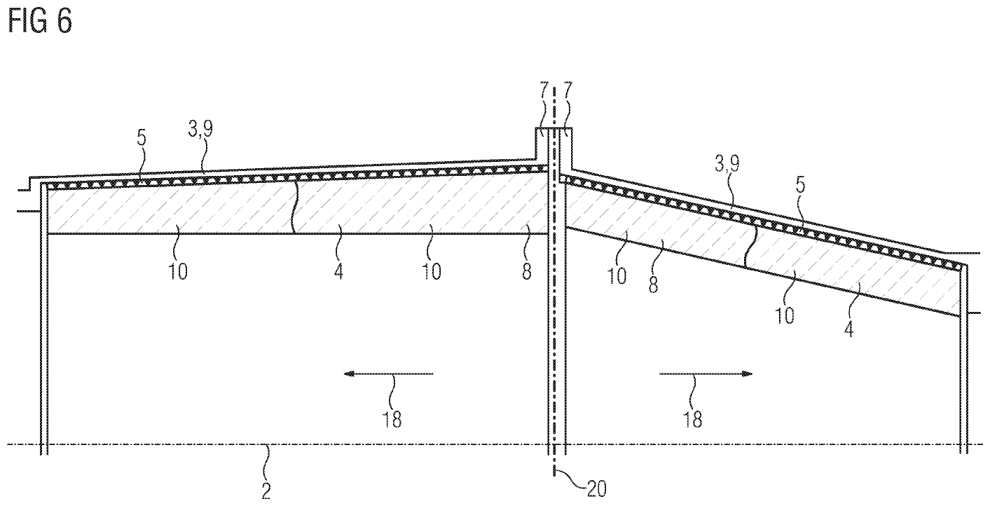

With the aim of limiting the joining forces and of cladding variable geometries, the metallic component can be separated into two conical components (for example with a separating plane 20 displaced into the center, as shown in FIG. 6). The respective other partial jacket 9 with the corresponding ceramic tube 4 acts here as a counterpart 8 for the axial tensioning 18.

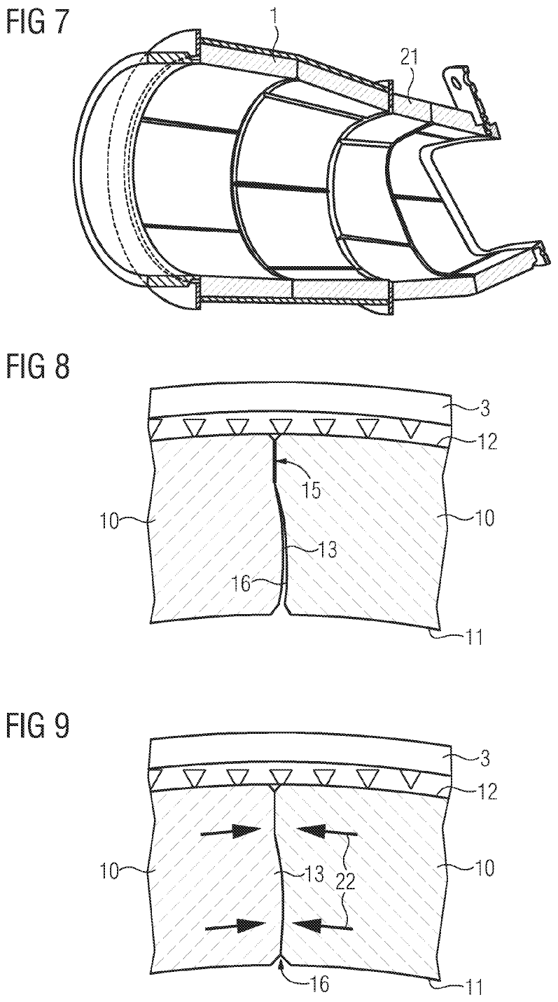

FIG. 7 shows a tubular combustion chamber 1 which is cut away in the longitudinal direction and has transition piece 21, in which a cladding, as illustrated in FIG. 6, is provided.

FIGS. 8 to 10 show details of the geometry between individual ceramic heat shield segments 10 in a ceramic-metal assembly which is under external pressure.

FIG. 8 shows two adjacent heat shield segments 10 in the fitted state. The heat shield segments 10 each have a hot side 11 to which a hot medium can be applied, a cold side 12 which is opposite the hot side 11 and faces the jacket 3, and a circumferential rim 13 between the hot side 11 and the cold side 12. The heat shield segments 10 have, on the rim 13, bearing surfaces 15 which adjoin the cold side 12 and serve for transmitting force in the tangential and axial direction, and gaps 16 opening toward the hot gas side 11. The gaps 16 opening toward the hot gas side are sickle-shaped, similarly to the function of a tongue and groove joint. The gap 16 per se ensures an unobstructed thermal expansion, and the shape of the gap 16 permits a form fit and therefore a definition of the position in the radial direction.

FIG. 9 shows the same two heat shield segments 10 as FIG. 8. The difference consists in that the heat shield segments 10 of FIG. 8 are in a cold state, and those of FIG. 9 are in a hot state and the gap 16 is closed because of the thermal expansion 22.

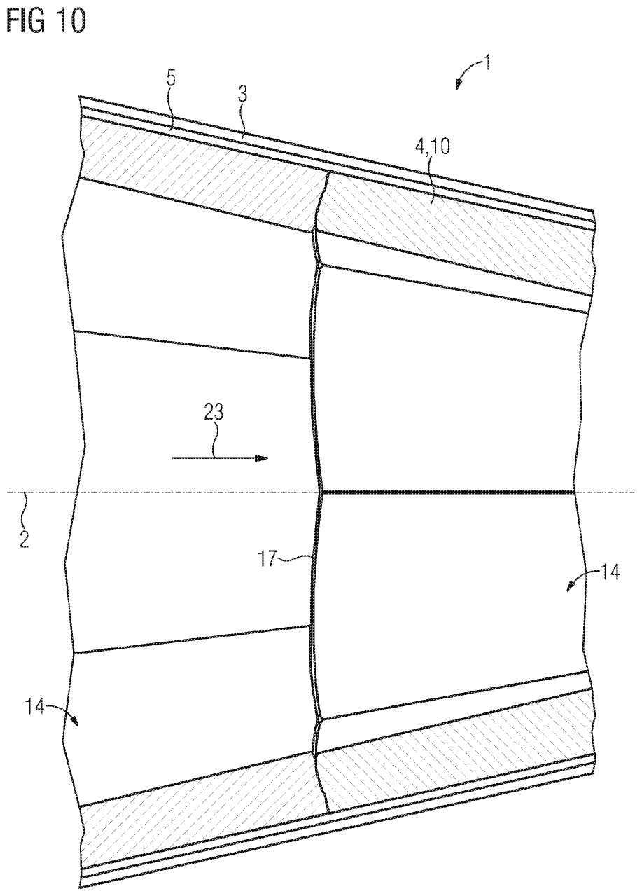

In order to prevent rotation in the circumferential direction between the segment rows 14 of heat shield segments 10 arranged in the circumferential direction, the end surfaces 17 of the heat shield segments 10 should not be designed to be even, but rather in such a manner that a form fit arises between the individual ceramic heat shield segments 10 in the circumferential direction. For this purpose, the interface geometry should advantageously be in the form of a wavy geometry, as illustrated in FIG. 10, or in the form of any other geometry ensuring a form fit. FIG. 10 shows a section through a combustion chamber 1 with two segment rows 14. The flow direction 23 of the hot gases during operation is likewise indicated.

The side and end surface geometry should, of course, be designed so as to be adapted to the expansion so that the gaps 16 and also between the segment rows 14 during the operation is minimized in order very substantially to avoid the penetration of hot gas. Use should advantageously be made here of obtuse angles and large radii in order to avoid zones loaded with tension stress.

1. A combustion chamber, comprising:
a jacket which is arranged around a principal axis of the combustion chamber, and
a ceramic tube which is arranged inside the jacket, and
an intermediate layer, wherein the intermediate layer is arranged between the jacket and the ceramic tube, and the jacket is at least partially conical, and the ceramic tube is tensioned axially into the jacket along the principal axis,
wherein the ceramic tube is an assembly of a plurality of heat shield segments, wherein the heat shield segments each have a hot side to which a hot medium can be applied, a cold side which is opposite the hot side and faces the jacket, and a circumferential rim between the hot side and the cold side, and, in a cold state, individual heat shield segments of a segment row have, on the circumferential rim, bearing surfaces that adjoin the cold side and gaps opening toward the hot side.

2. The combustion chamber as claimed in claim 1,
wherein the gaps are sickle-shaped.

3. The combustion chamber as claimed in claim 1,
wherein uneven end surfaces are provided between segment rows, and in a hot state, a form fit arises between individual heat shield segments in a circumferential direction.

4. The combustion chamber as claimed in claim 1,
wherein the jacket is metallic.

5. The combustion chamber as claimed in claim 1,
wherein the ceramic tube is composed of fireproof material.

6. The combustion chamber as claimed in claim 1,
wherein the intermediate layer is a ceramic swellable mat.

7. The combustion chamber as claimed in claim 1,
wherein the intermediate layer comprises spring and/or damping elements.

8. The combustion chamber as claimed in claim 7,
wherein the spring and/or damping elements are ceramic.

9. The combustion chamber as claimed in claim 7,
wherein the spring and/or damping elements are metallic.

10. The combustion chamber as claimed in claim 1,
wherein the jacket has fastening means at the opening having the largest opening diameter, wherein the fastening means is useable to draw a counterpart against the opening.

11. The combustion chamber as claimed in claim 1,
wherein the jacket comprises two conical partial jackets.

12. The combustion chamber as claimed in claim 1,
wherein the ceramic tube is a full cylinder.

13. The combustion chamber as claimed in claim 1,
wherein the ceramic tube is a full cone.
